(19) United States
(12) Patent Application Publication
(10) Pub. No.: US 2025/0069615 A1
(43) Pub. Date: Feb. 27, 2025

(54) ACOUSTIC SIGNAL PROCESSING DEVICE, ACOUSTIC SIGNAL PROCESSING METHOD, AND COMPUTER PROGRAM PRODUCT

(71) Applicants: KABUSHIKI KAISHA TOSHIBA, Tokyo (JP); TOSHIBA DIGITAL SOLUTIONS CORPORATION, Kawasaki-shi Kanagawa (JP)

(72) Inventors: Naoki HIRAYAMA, Kawasaki Kanagawa (JP); Yusaku KIKUGAWA, Nishitama Tokyo (JP); Masahide ARIU, Fujisawa Kanagawa (JP)

(73) Assignees: KABUSHIKI KAISHA TOSHIBA, Tokyo (JP); TOSHIBA DIGITAL SOLUTIONS CORPORATION, Kawasaki-shi Kanagawa (JP)

(21) Appl. No.: 18/944,731

(22) Filed: Nov. 12, 2024

Related U.S. Application Data
(63) Continuation of application No. PCT/JP2023/017957, filed on May 12, 2023.

(30) Foreign Application Priority Data
May 24, 2022 (JP) 2022-084452

(51) Int. Cl. G10L 21/0216; G10L 25/78; G10L 25/84

(52) U.S. Cl. CPC G10L 21/0216; G10L 25/84; G10L 2025/783

(57) ABSTRACT

The recognition rate can be improved even in a noise environment and without relying on the voice-recognition result. An acoustic signal processing device includes a spatial filter control unit, a spatial filter storing unit, and an acoustic processing unit. The spatial filter control unit outputs a spatial filter for emphasizing the target voice component and suppressing the noise component for N number of temporally-synchronized acoustic signals (N≥2) recorded at different positions. The spatial filter storing unit stores therein the spatial filter. Using the spatial filter read from the spatial filter storing unit, the acoustic processing unit emphasizes the target voice component in the acoustic signals, and suppresses the noise component in the acoustic signals. The spatial filter control unit further includes a determining unit, a voice spatial correlation calculating unit, a noise spatial correlation calculating unit, a spatial correlation storing unit, and a spatial filter calculating unit.

### CROSS-REFERENCE TO RELATED APPLICATIONS

This application is a continuation of International Patent Application No. PCT/JP2023/017957 filed on May 12, 2023 which claims the benefit of priority from Japanese Patent Application No. 2022-084452, filed on May 24, 2022; the entire contents of all of which are incorporated herein by reference.

### FIELD

Embodiments described herein relate generally to an acoustic signal processing device, an acoustic signal processing method, and a computer program product.

### BACKGROUND

Conventionally, a technology is known for which, with respect to acoustic signals recorded using two or more microphones that are installed at different positions, acoustic processing is performed by emphasizing the target voice to be the target for voice recognition and by suppressing the noise which should not be the target for voice recognition; thereby enabling improvement in the recognition rate of voice recognition. For example, a technology is known for which, when a keyword is detected by means of voice recognition, the signals within the time section in which that keyword is uttered are assumed as the target voice; the signals outside the time section in which that keyword is uttered are assumed as noise; and a spatial filter is calculated for performing acoustic processing to emphasize the target voice and to suppress the noise.

### BRIEF DESCRIPTION OF THE DRAWINGS

FIG. 1 is a diagram illustrating an exemplary functional configuration of a voice recognition device according to a first embodiment;

FIG. 2 is a diagram illustrating an exemplary functional configuration of a spatial filter control unit according to the first embodiment;

FIG. 3 is a flowchart for explaining an exemplary acoustic signal processing method according to the first embodiment;

FIG. 4 is a flowchart for explaining an exemplary updating method for updating a spatial filter according to the first embodiment;

FIG. 5 is a diagram illustrating an exemplary functional configuration of a voice recognition device according to a second embodiment;

FIG. 6 is a diagram illustrating an exemplary functional configuration of a spatial filter control unit according to the second embodiment;

FIG. 7 is a flowchart for explaining an exemplary acoustic signal processing method according to the second embodiment;

FIG. 8 is a flowchart for explaining an exemplary updating method for updating a spatial filter according to the second embodiment; and

FIG. 9 is a diagram illustrating an exemplary hardware configuration of the voice recognition devices according to the first and second embodiments.

### DETAILED DESCRIPTION

According to an embodiment, an acoustic signal processing device includes one or more hardware processors configured to function as a spatial filter control unit, a spatial filter storing unit, and an acoustic processing unit. The spatial filter control unit includes a determining unit, a voice spatial correlation calculating unit, a noise spatial correlation calculating unit, a spatial correlation storing unit, and a spatial filter calculating unit. The spatial filter control unit outputs a spatial filter used for emphasizing a target voice component and for suppressing a noise component with respect to N number of temporally-synchronized acoustic signals recorded at different positions, where N is an integer equal to or greater than 2. The spatial filter storing unit stores therein the spatial filter. The acoustic processing unit, using the spatial filter read from the spatial filter storing unit, emphasizes a target voice component in an acoustic signal and suppresses a noise component in the acoustic signal. The determining unit determines whether the acoustic signal represents a target voice or a noise. The voice spatial correlation calculating unit calculates a voice spatial correlation matrix using a voice section which, among the acoustic signals, is determined to represent the target voice. The noise spatial correlation calculating unit calculates a noise spatial correlation matrix using a noise section which, among the acoustic signals, is determined to represent the noise. The spatial correlation storing unit stores therein the voice spatial correlation matrix and the noise spatial correlation matrix. The spatial filter calculating unit calculates, from the voice spatial correlation matrix and the noise spatial correlation matrix read from the spatial correlation storing unit, the spatial filter used for emphasizing the target voice component and for suppressing the noise component.

Exemplary embodiments of an acoustic signal processing device, an acoustic signal processing method, and a computer program product will be explained below in detail with reference to the accompanying drawings.

### First Embodiment

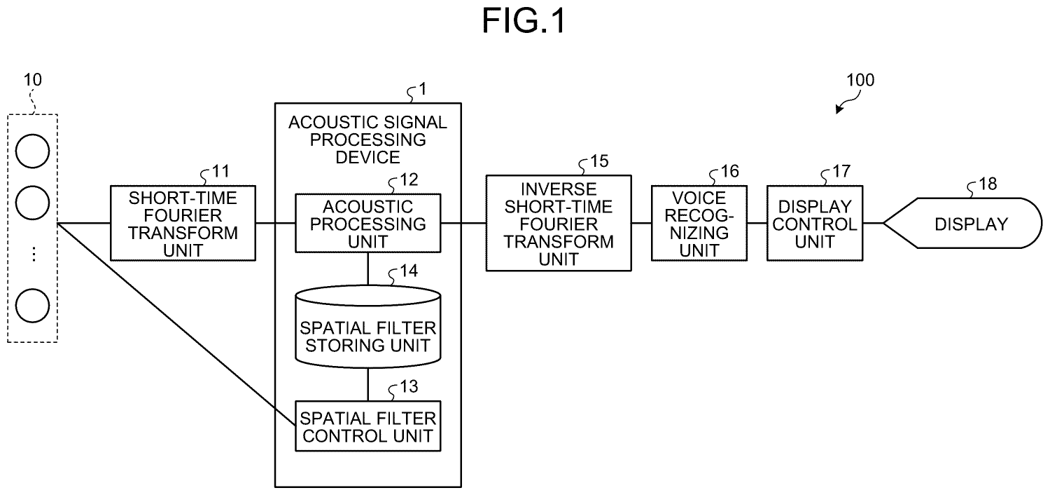

In an acoustic signal processing device according to a first embodiment, it is determined whether the acoustic signals input at each timing represent the target voice or noise; and a spatial filter is calculated in such a way that the acoustic signals in the section determined to be the target voice are emphasized, and the acoustic signals in the section determined to be the noise are suppressed. Then, in the acoustic signal processing device, the acoustic signals subjected to noise suppression are output using a spatial filter. As the acoustic signal processing device according to the first embodiment, for example, a voice recognition device illustrated in FIG. 1 is used.

### Example of Functional Configuration of Voice Recognition Device

### Exemplary Functional Configuration of Voice Recognition Device

FIG. 1 is a diagram illustrating an exemplary functional configuration of a voice recognition device 100 according to the first embodiment. The voice recognition device 100 according to the first embodiment includes a microphone array 10, a short-time Fourier transform unit 11, an acoustic processing unit 12, a spatial filter control unit 13, a spatial filter storing unit 14, an inverse short-time Fourier transform unit 15, a voice recognizing unit 16, a display control unit 17, and a display 18.

Herein, the acoustic processing unit 12, the spatial filter control unit 13, and the spatial filter storing unit 14 are equivalent to an acoustic signal processing device 1 according to the first embodiment. In the voice recognition device 100 according to the first embodiment, by performing voice recognition at a later stage using the output acoustic signals, the recognition rate of voice recognition can be improved without using the voice recognition result.

The microphone array 10 includes N number of microphones (N≥2, i.e, N is an integer equal to or greater than 2) installed at different positions, and obtains temporally-synchronized N number of acoustic signals xₘ(t) (m=1, 2, . . . , N). Herein, “m” represents the number assigned to a microphone.

The short-time Fourier transform unit 11 applies a window function with respect to the N number of acoustic signals xₘ(t) for generating a plurality of frames; performs short-time Fourier transform on a frame-by-frame basis and converts the frames into time-frequency regions; and outputs frequency spectral sequences Xₘ(f, k). Herein, “f” represents the frequency bin number, and “k” represents the number assigned to a frame.

The acoustic processing unit 12 emphasizes the target voice component and suppresses the noise component included in the N number of frequency spectral sequences; and outputs a single frequency spectral sequence Y(f, k). Meanwhile, the acoustic processing unit 12 can use the actual acoustic signals as the input and the output. Examples of the noise suppression method include a GEV (generalized eigenvalue) beamformer, a MVDR (minimum variance distortionless response) beamformer, and their derived methods.

The spatial filter control unit 13 uses the N number of acoustic signals and updates the values in the spatial filter storing unit 14. For example, in the case of using a GEV beamformer, from the frequency spectrums of the frames corresponding to the voice section and the frequency spectrums of the frames corresponding to the noise section, the spatial filter control unit 13 calculates the average value of spatial correlation matrices corresponding to the target voice and calculates the average value of spatial correlation matrices corresponding to the noise; and then calculates a spatial filter from the average values.

The spatial filter storing unit 14 stores therein the value of the spatial filter used for emphasizing the target voice and suppressing the noise.

The inverse short-time Fourier transform unit 15 performs inverse short-time Fourier transform with respect to a frequency spectral sequence output from the acoustic processing unit 12, and outputs a single acoustic signal y(t) for which the target voice is emphasized and the noise is suppressed.

The voice recognizing unit 16 performs voice recognition with respect to the acoustic signal y(t), and obtains the voice recognition result. Particularly, in the first embodiment, the voice recognizing unit 16 obtains the detection result about keyword utterance.

The display control unit 17 performs control to display the voice recognition result in the display 18. The display 18 (an example of a display unit) is used to display the voice recognition result.

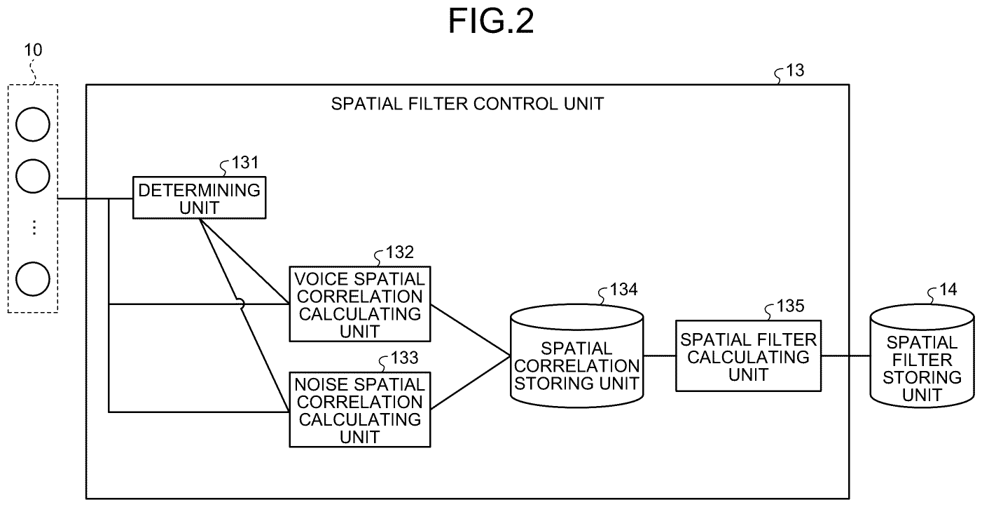

Explained below with reference to FIG. 2 are the functions of the spatial filter control unit 13 representing the characteristic part according to the first embodiment.

### Exemplary Functional Configuration of Spatial Filter Control Unit

FIG. 2 is a diagram illustrating an exemplary functional configuration of the spatial filter control unit 13 according to the first embodiment. The spatial filter control unit 13 according to the first embodiment is connected to the microphone array 10 and the spatial filter storing unit 14. The spatial filter control unit 13 includes a determining unit 131, a voice spatial correlation calculating unit 132, a noise spatial correlation calculating unit 133, a spatial correlation storing unit 134, and a spatial filter calculating unit 135.

The determining unit 131 determines whether the acoustic signals in each frame input from the microphone array 10 represent the target voice that should be recognized or represent noise that should be suppressed. For example, regarding the acoustic signals, the determining unit 131 calculates the value of a voice score indicating the voice-likeness. If the voice score is greater than a voice threshold value, then the determining unit 131 determines that the acoustic signal represents the target voice. On the other hand, if the voice score is equal to or smaller than the voice threshold value, then the determining unit 131 determines that the acoustic signal represents the noise.

More particularly, using a pre-learnt deep neural network (DNN), the determining unit 131 determines whether acoustic signals represent the target voice that should be recognized or represent noise that should be suppressed.

For example, the determining unit 131 uses a DNN that determines as the target voice or noise with acoustic signals in a single frame as the input and determines that the acoustic signal represents the target voice when the voice score obtained by inputting the acoustic signals in each frame is greater than the voice threshold value. By performing the determination based on the voice score output by a pre-learnt model such as a DNN, it becomes possible to perform determination using complex information. Meanwhile, the threshold value to be used in the determination can be implemented as a constant number. Alternatively, an interface for externally setting the threshold value can be provided. Moreover, the determining unit 131 can perform the determination according to the frequency spectrum of each frame that is output from the short-time Fourier transform unit 11.

Alternatively, a continuous value can be allowed as the determination result and, in the voice spatial correlation calculating unit 132 and the noise spatial correlation calculating unit 133, updating can be performed by assigning a weight according to the value of the determination result. Moreover, the determination of the target voice and the determination of the noise can be independently performed using different determinators. As the input signal at the time of determination, a single acoustic signal from among the N number of acoustic signals, or a single acoustic signal after noise suppression is usable. Furthermore, such signals can be used which are obtained by removing the noise component from the N number of acoustic signals by separately implementing an independent component analysis method.

Meanwhile, some other determination methods can also be considered. For example, the determining unit 131 can perform the determination regarding the acoustic signals obtained by each microphone, and can treat a statistic amount of such as the average value, or the maximum value and the minimum value of each determination result, as the overall determination result.

Alternatively, either by implementing the method proposed by M. Wax and T. Kailath 1985 in which the number of sound sources is estimated according to the number of dominant eigenvalues included in the spatial correlation matrices calculated from the N number of acoustic signals or by implementing a derived method of the abovementioned method, the determining unit 131 can determine that the target voice is present when the dominant eigenvalues are present. That is, the determining unit 131 can include a sound source count estimator for estimating the number of sound sources involved with the acoustic signals, and the voice score can be represented by a function of the number of sound sources. By using the number of sound sources to determine the presence or absence of the target voice, when the noise is diffusive and when the power of the target voice is sufficiently greater than the noise, it becomes possible to improve the determination accuracy of the determining unit 131.

Alternatively, for example, the determining unit 131 can calculate the power of the N number of acoustic signals; and, when the voice score that is represented by a function of the statistic based on the power of the acoustic signals is greater than a voice threshold value, can determine that the target voice is present. As the statistic, it is possible to think of the average and the dispersion of the power in the time direction of each frequency bin. If there is a significant difference between the statistic of the target voice and the statistic of the noise, then the determining unit 131 can be implemented with less complexity.

Still alternatively, for example, when it can be assumed that the relative direction of the target speaker when viewed from the microphone array 10 is fixed, a sound source localization method such as the MUSIC (Multiple Signal Classification) method (R. O. Schmidt 1986) can be implemented with respect to the N number of acoustic signals; and, only when the sound source is arriving from the direction of that target speaker, it can be determined that the target speaker is making an utterance. In that case, the spatial filter control unit 13 can further include: a speaker direction setting unit that holds the relative direction of the target speaker when viewed from a microphone; and a sound source localizing unit that performs sound source localization with respect to the acoustic signals and outputs the detected sound source direction. Then, regarding at least a single sound source direction, if the angular difference from the relative direction set by the speaker direction setting unit is equal to or smaller than an angle threshold value, then the determining unit 131 determines that the target voice is present. On the other hand, if the angular difference is greater than the angle threshold value, then the determining unit 131 determines that noise is present. By using the sound source direction information to determine the presence or absence or the target voice, it becomes possible to determine whether or not there is utterance from the direction of a known target speaker. Hence, when other speakers other than the target speaker are present, the voices of the other speakers can be suppressed only using the acoustic signals.

When the determining unit 131 determines as the target voice, the voice spatial correlation calculating unit 132 uses the acoustic signals in each frame and updates a voice spatial correlation matrix stored in the spatial correlation storing unit 134. More particularly, when the acoustic signals are determined to represent the target voice, the voice spatial correlation calculating unit 132 reads the voice spatial correlation matrix from the spatial correlation storing unit 134; calculates a voice spatial correlation matrix; and writes the calculated voice spatial correlation matrix in the spatial correlation storing unit 134 (a voice spatial correlation matrix updating operation).

As an example of the updating method, a method is thinkable for which the acoustic signals of a certain period of time in the past and the determination result obtained by the determining unit 131 are stored, and a voice spatial correlation matrix is calculated using only the acoustic signals in the sections determined to represent voices. For example, the determining unit 131 can include an acoustic signal storing unit for holding the acoustic signals included before a predetermined period of time from the current timing. The determining unit 131 determines whether or not the acoustic signal in each frame included before the predetermined period of time from the current timing represents the target voice. The voice spatial correlation calculating unit 132 calculates a voice spatial correlation matrix using the acoustic signals included before the predetermined period of time from the current timing, and stores that voice spatial correlation matrix in the spatial correlation storing unit 134. A valid voice recognition result can be obtained only when the target utterance is included in the acoustic signals. Hence, in the example of the updating method, it is assumed that the target utterance is included in the most recent acoustic signals (i.e., the acoustic signals included before the predetermined period of time from the current timing). For example, when T number of frames represent the predetermined period of time, if the determining unit 131 determines that the acoustic signals in the k-th frame represent the target voice, then a voice spatial correlation matrix ϕₛ(f, k) is calculated according to Equation (1) given below.

$${Φ}_{s} ( f , k ) = \frac{{\sum }_{k = k - T + 1}^{k} \text{?} s ( {k}^{′} ) X ( f , {k}^{′} ) {X ( f , {k}^{′} )}^{H}}{{\sum }_{k = k - T + 1}^{k} \text{?} ( {k}^{′} )} \qquad ( 1 )$$

$$\text{?} \text{indicates text missing or illegible when filed}$$

Herein, X(f, k) represents a vertical vector (X₁(f, k), . . . , X_{N}(f, k))^{T}; H represents the conjugate transpose; s(k) represents a function that returns “1” when the determination result obtained by the determining unit 131 with respect to the k-th frame represents the target voice and returns “0” when the determination result represents noise. Because the assumption is s(k)=1, it can be assumed that the denominator of Equation (1) is not “0”.

As another example, it is possible to think of a method in which, in order to reduce the buffering and the complexity of the acoustic signals, the voice spatial correlation matrix is successively updated using the exponentially smoothed moving average. For example, when s(k)=1, the voice spatial correlation matrix ϕₛ(f, k) is calculated according to Equation (2) given below. On the other hand, when s(k)=0, the voice spatial correlation matrix ϕₛ(f, k) is set to ϕₛ(f, k−1). Herein, αₛ is a constant number satisfying 0<αₛ<1.

$${Φ}_{s} ( f , k ) = ( 1 - {α}_{s} ) {Φ}_{s} ( f , k - 1 ) + {α}_{s} X ( f , k ) {X ( f , k )}^{H} \qquad ( 2 )$$

Meanwhile, instead of using the determination result s(k) of the determining unit 131 as a binary value of “0” or “1”, a continuous value indicating the degree of the acoustic signal representing the target voice is settable and the voice spatial correlation calculating unit 132 can update the voice spatial correlation matrix by increasing, as the continuous value is increased, the weighting of the proportion of updating the values of the voice spatial correlation matrix. For example, for the continuous value representing the determination result is in the range from “0” to “1” and as nearing “1”, the degree of being the target voice is increased. For example, using the determination result s(k), the voice spatial correlation matrix ϕₛ(f, k) is calculated according to Equation (3) given below.

$${Φ}_{s} ( f , k ) = ( 1 - {α}_{s} s ( k ) ) {Φ}_{s} ( f , k - 1 ) + {α}_{s} s ( k ) ) X ( f , k ) {X ( f , k )}^{H} \qquad ( 3 )$$

When the output of the determining unit 131 is set as a continuous value instead of a binary value, such weighting can be performed in the calculation of the voice spatial correlation matrix according to the reliability of the determination. As a result, the voice spatial correlation can be calculated with more precision, and the voice improvement performance in the acoustic processing can be further improved.

When the determining unit 131 determines as the noise, the noise spatial correlation calculating unit 133 updates a noise spatial correlation matrix, which is stored in the spatial correlation storing unit 134, using the acoustic signals in each frame. More particularly, when it is determined that the acoustic signal represents the noise, the noise spatial correlation calculating unit 133 reads the noise spatial correlation matrix from the spatial correlation storing unit 134; calculates a noise spatial correlation matrix; and writes the calculated noise spatial correlation matrix in the spatial correlation storing unit 134 (a noise spatial correlation matrix updating operation). Meanwhile, the acoustic signal processing device 1 according to the first embodiment can perform either only one or both of the noise spatial correlation matrix updating operation and the voice spatial correlation matrix updating operation explained earlier.

The updating method for updating the noise spatial correlation matrix is identical to the updating method for updating the voice spatial correlation calculating unit 132. For example, using the acoustic signals included before a predetermined period of time from the current timing, a noise spatial correlation matrix is calculated according to Equation (4) given below, and the calculated noise spatial correlation matrix is stored in the spatial correlation storing unit 134.

$$( 4 )$$

$${Φ}_{n} ( f , k ) = \frac{{\sum }_{k = k - T + 1}^{k} \text{?} ( 1 - s ( {k}^{′} ) X ( f , {k}^{′} ) {X ( f , {k}^{′} )}^{H}}{{\sum }_{k = k - T + 1}^{k} \text{?} ( 1 - s ( {k}^{′} ) )}$$

$$\text{?} \text{indicates text missing or illegible when filed}$$

In order to reduce the buffering and the complexity of the acoustic signals, the noise spatial correlation matrix can be successively updated using the exponentially smoothed moving average. Here, with the determination result obtained by the determining unit 131 as the continuous value, the noise spatial correlation calculating unit 133 can calculate the noise spatial correlation matrix by increasing, as the continuous value is decreased, the weighting of the proportion of updating values of the noise spatial correlation matrix. For example, based on the exponentially smoothed moving average, a noise spatial correlation matrix ϕₙ(f, k) is calculated according to Equation (5) given below.

$$( 5 )$$

$${Φ}_{n} ( f , k ) = ( 1 - {α}_{n} ( 1 - s ( k ) ) ) {Φ}_{n} ( f , k - 1 ) + {α}_{n} - s ( k ) ) X ( f , k ) {X ( f , k )}^{H}$$

Herein, an is a constant number satisfying 0<αₙ<1. The determination result s(k) either can take the binary value of “0” or “1” or can take a continuous value in the range from “0” to “1”. In an identical manner to the voice spatial correlation calculating unit 132, since the output of the determining unit 131 is a continuous value instead of a binary value, during the calculation of the noise spatial correlation matrix, weighting can be performed according to the reliability of the determination. As a result, the noise spatial correlation can be calculated with more precision, and the noise suppression performance in the acoustic processing can be further improved.

Meanwhile, in order to emphasize the most recent target voice in a more reliable manner, regardless of the determination result obtained by the determining unit 131, the voice spatial correlation calculating unit 132 can update the voice spatial correlation matrix according to Equation (1) or Equation (2); and, when the determination result regarding the acoustic signals during a certain period of time in the past indicates the presence of noise, the noise spatial correlation calculating unit 133 can update the noise spatial correlation matrix using those acoustic signals in the past. For example, the determining unit 131 can include an acoustic signal storing unit for holding the acoustic signals included before a predetermined period of time from the current timing. Then, the determining unit 131 determines whether or not the acoustic signals before the predetermined period of time represent noise. If it is determined that the acoustic signals before the predetermined period of time represent noise, then the noise spatial correlation calculating unit 133 calculates the noise spatial correlation matrix using the acoustic signals before the predetermined period of time, and stores that noise spatial correlation matrix in the spatial correlation storing unit 134. For example, if D number of frames (where D>0) represents the predetermined period of time; then, regardless of the determination result obtained by the determining unit 131, the voice spatial correlation matrix is calculated according to Equation (2) given earlier; and, when the determining unit 131 determines that the acoustic signals before the D number of frames represent noise (i.e., determines as s(k−D)=0), the noise spatial correlation matrix is calculated according to Equation (6) given below.

$$( 6 )$$

$${Φ}_{n} ( f , k ) = ( 1 - {α}_{n} ) {Φ}_{n} ( f , k - 1 ) + {α}_{n} X ( f , k - D ) {X ( f , k - D )}^{H}$$

only when the target utterance is included in the acoustic signals. Thus, while the target utterance is reliably included in the calculation of the voice spatial correlation, the calculation of the noise spatial correlation is performed using delayed acoustic signals (i.e., the acoustic signals before the predetermined period of time). As a result, it becomes possible to improve the noise suppression effect when the target utterance is included.

The spatial correlation storing unit 134 stores therein the values of the spatial correlation matrices calculated by the voice spatial correlation calculating unit 132 and the noise spatial correlation calculating unit 133.

The spatial filter calculating unit 135 uses the spatial correlation matrices stored in the spatial correlation storing unit 134 and calculates a spatial filter used for emphasizing the target voice and suppressing the noise; and updates the spatial filter storing unit 14 with the value of the calculated spatial filter. The spatial filter calculation is performed based on a method such as GEV beamformer or MVDR beamformer.

### Example of Acoustic Signal Processing Method

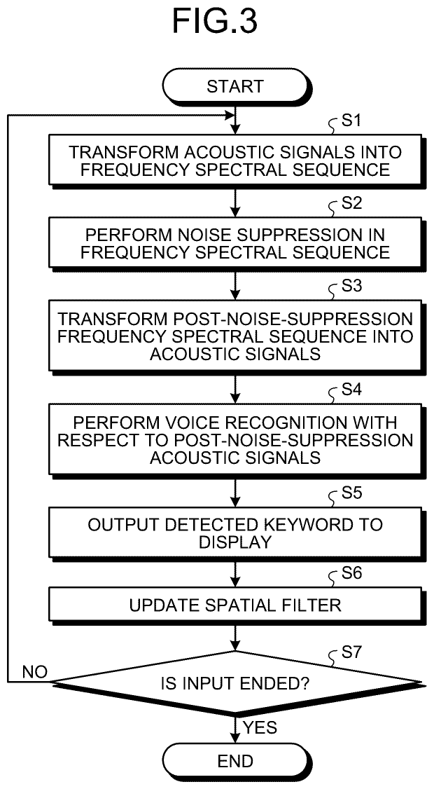

FIG. 3 is a flowchart for explaining an exemplary acoustic signal processing method according to the first embodiment. Firstly, the short-time Fourier transform unit 11 transforms the acoustic signals, which are input from the microphone array 10, into a frequency spectral sequence (Step S1). Then, using the spatial filter stored in the spatial filter storing unit 14, the acoustic processing unit 12 performs noise suppression in the frequency spectral sequence input from the short-time Fourier transform unit 11 (Step S2). Subsequently, the inverse short-time Fourier transform unit 15 transforms the frequency spectral sequence output by the acoustic processing unit 12 (i.e., transforms the post-noise-suppression frequency spectral sequence) into acoustic signals (Step S3). Then, the voice recognizing unit 16 performs voice recognition with respect to the acoustic signals output by the inverse short-time Fourier transform unit 15 (i.e., with respect to the post-noise-suppression acoustic signals) (Step S4).

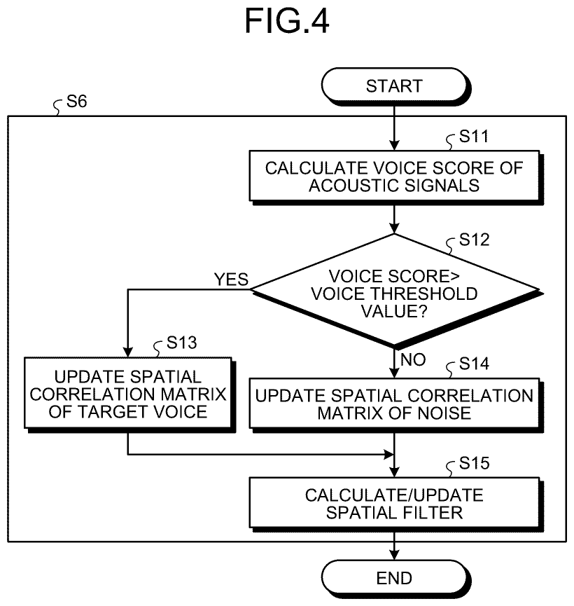

Subsequently, the display control unit 17 displays/outputs, in/to the display 18, the information about the keyword detected by voice recognition performed by the voice recognizing unit 16 (Step S5). Then, using the acoustic signals input from the microphone array 10, the spatial filter control unit 13 updates the value of the spatial filter stored in the spatial filter storing unit 14 (Step S6). Regarding the operation performed at Step S6 (i.e., an updating method for updating the spatial filter), the detailed explanation is given later with reference to FIG. 4.

Then, the acoustic processing unit 12 determines whether or not the input of the acoustic signals reaches the end (Step S7). If the input of the acoustic signals reaches the end (Yes at Step S7), the operations are ended. However, if the input of the acoustic signals does not reach the end (No at Step S7), the system control returns to Step S1, and the same operations are repeatedly performed for the subsequent input.

### Exemplary Updating Method for Updating Spatial Filter

FIG. 4 is a flowchart for explaining an exemplary updating method for updating the spatial filter according to the first embodiment. Firstly, the determining unit 131 calculates the voice score indicating the voice-likeness of the acoustic signals input from the microphone array 10 (Step S11). Then, the determining unit 131 compares the voice score with a predetermined voice threshold value (or an externally-set voice threshold value) (Step S12).

If the voice score is greater than the voice threshold value (Yes at Step S12), then the voice spatial correlation calculating unit 132 uses the acoustic signals input from the microphone array 10 and updates the spatial correlation matrix of the target voice according to Equation (1), or Equation (2), or Equation (3) given earlier (Step S13).

On the other hand, if the voice score is equal to or smaller than the voice threshold value (No at Step S12), then the noise spatial correlation calculating unit 133 uses the acoustic signals input from the microphone array 10 and updates the spatial correlation matrix of the noise according to Equation (4), or Equation (5), or Equation (6) given earlier (Step S14).

Then, the spatial filter calculating unit 135 calculates the value of the spatial filter using the spatial correlation matrix of the target voice and the spatial correlation matrix of the noise, and updates that value in the spatial filter storing unit 14 (Step S15). The spatial correlation matrix of the target voice and the spatial correlation matrix of the noise are updated in response to the input of acoustic signals in each frame (i.e., are successively updated). Hence, every time, the spatial filter is calculated in accordance with the time variation in the position, the direction, and the frequency characteristics of the target noise and the noise.

As explained above, from the voice spatial correlation matrix, which is calculated from the voice section indicating the target voice for recognition included in the N number of temporally-synchronized acoustic signals (where N≥2) that are recorded at different positions, and from the noise spatial correlation matrix, which is calculated from the noise section indicating the target noise for suppression included in the acoustic signals; the spatial filter control unit 13 calculates the spatial filter used for emphasizing the target voice component and suppressing the noise component. Then, the spatial filter is stored in the spatial filter storing unit 14. Using the spatial filter, the acoustic processing unit 12 emphasizes the target voice component of the acoustic signals, and suppresses the noise component of the acoustic signals.

As a result, in the acoustic signal processing device 1 according to the first embodiment, improvement in the recognition rate can be achieved even in a noise environment and without relying on the voice recognition result. More particularly, in the acoustic signal processing device 1 according to the first embodiment, only the microphone array 10 is used as the input device, and the spatial filter can be calculated without relying on the output of the voice recognizing unit 16. Hence, it also becomes possible to keep a track of the time variation in the target voice and the noise.

In the conventional technology, the spatial filter calculation operation is triggered by the detection of a keyword. Hence, in the case in which a keyword is not detected, such as in the case when an utterance not related to any keyword is made, the spatial filter cannot be calculated. Moreover, since the acoustic processing is not performed until the detection of the initial keyword, it is not possible use the technology in an environment in which the noise power is high and voice recognition is difficult to perform without acoustic processing. Furthermore, the spatial filter at the point of time of detection of the first keyword is held until the second keyword is subsequently detected. Hence, with reference to the position of utterance of the first keyword, if the next utterance is made from a different position, then the noise suppression effect cannot be achieved in an appropriate manner.

In contrast, the spatial filter control unit 13 according to the first embodiment can determine about the target voice and the noise directly from the acoustic signals. Hence, the noise suppression effect can be achieved without relying on the voice recognizing unit 16. That enables configuring the voice recognition device 100 in such a way that a higher voice recognition rate is achieved with respect to the input acoustic signals without relying on the voice recognition result.

Meanwhile, the acoustic signals output from the acoustic processing unit 12 can be input to at least one of the determining unit 131, the voice spatial correlation calculating unit 132, and the noise spatial correlation calculating unit 133. By using the result obtained by once performing voice improvement/noise suppression with respect to the acoustic signals, the calculation of the voice spatial correlation and the noise spatial correlation can be performed with more precision, and the voice improvement/noise suppression performance during the acoustic processing can be further improved.

Meanwhile, the spatial filter control unit 13 can further include a sound source separating unit that performs sound source separation by implementing a method such as independent component analysis with respect to the input acoustic signals, and outputs separation acoustic signals that are separated into the target voice component and the noise component. Then, the separation acoustic signals can be input to at least one of the determining unit 131, the voice spatial correlation calculating unit 132, the noise spatial correlation calculating unit 133, and the acoustic processing unit 12. By separating the acoustic signals into the target voice component and the noise component, the calculation of the voice spatial correlation and the noise spatial correlation can be performed with more precision, and the voice improvement/noise suppression performance during the acoustic processing can be further improved.

Moreover, the determining unit 131 can calculate, regarding the acoustic signals, a target-voice score indicating the target-voice-likeness and a noise score indicating the noise-likeness. In that case, if the target-voice score is greater than the voice threshold value, then the determining unit 131 determines that the acoustic signal represents the target voice. On the other hand, if the noise score is greater than the noise threshold value, then the determining unit 131 determines that the acoustic signal represent noise. By separately outputting the target-voice score and the noise score, the determining unit 131 becomes able to implement different algorithms for the determination of the target voice and the determination of the noise. Moreover, by ensuring that the data for which determination is difficult is not used in calculating the voice spatial correlation matrix and the noise spatial correlation matrix, it becomes possible to prevent any adverse impact of erroneous determination on the acoustic signal processing.

### Second Embodiment

Given below is the description of a second embodiment. In the second embodiment, the explanation identical to the explanation given in the first embodiment is not repeated. Thus, the explanation is given only about the differences with the first embodiment.

In an acoustic signal processing device according to the second embodiment, a video taken by a camera and capturing the target speaker is treated as the input and it is determined whether or not the target speaker is making an utterance at each timing. Then, a spatial filter is calculated in such a way that the acoustic signals in the section in which the target speaker is determined to be making an utterance are emphasized, and that the acoustic signals in the section in which the target speaker is determined not to be making an utterance are suppressed. Then, in the acoustic signal processing device, voice recognition is performed with respect to the acoustic signals having been subjected to noise suppression using the spatial filter. As a result, the recognition rate of voice recognition can be enhanced without having to use the voice recognition result. Moreover, the voices of the speakers other than the target speaker can also be suppressed, which is a difficult task in the case of using the voice score.

### Exemplary Functional Configuration of Voice Recognition Device

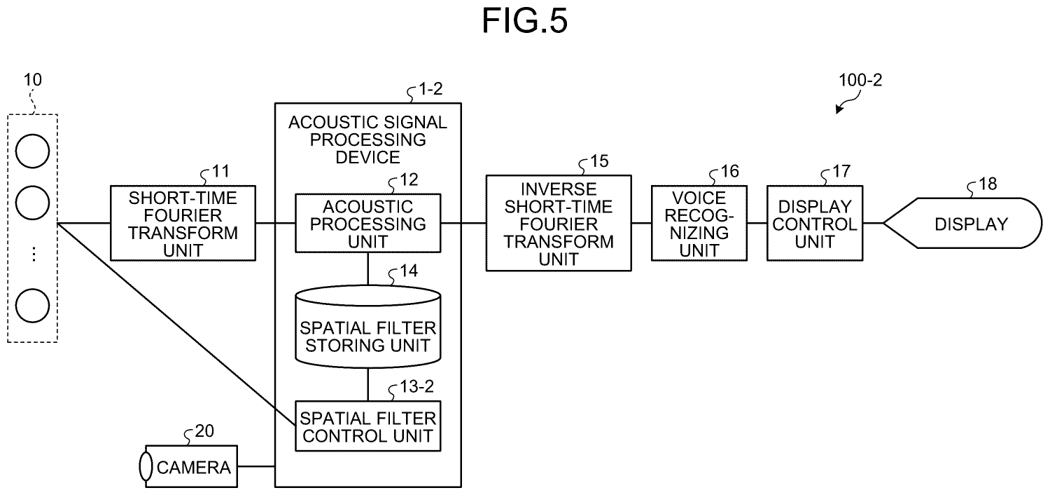

FIG. 5 is a diagram illustrating an exemplary functional configuration of a voice recognition device 100-2 according to the second embodiment. The voice recognition device 100-2 according to the second embodiment includes the microphone array 10, a camera 20, the acoustic processing unit 12, a spatial filter control unit 13-2, the spatial filter storing unit 14, the voice recognizing unit 16, the display control unit 17, and the display 18. Herein, the acoustic processing unit 12, the spatial filter control unit 13-2, and the spatial filter storing unit 14 are equivalent to an acoustic signal processing device 1-2 according to the second embodiment.

The camera 20 is installed in such a way that the face of the target speaker gets constantly captured, and outputs a face image of the target speaker at each timing. In the second embodiment, the relative position between the camera 20 and the target speaker is assumed to be constant, and the camera is fixedly oriented toward the speaker so that the face images of the target speaker are obtained on a constant basis. Instead of allowing moving of the target speaker, the camera 20 can be configured to track the target speaker and the face images of the target speaker can be obtained on a constant basis. In order to perform face tracking, it is possible to implement a known technology such as KLT (Kanade-Lucas-Tomasi) Tracker (B. D. Lucas and T. Kanade 1981).

The spatial filter control unit 13-2 updates the value in the spatial filter storing unit 14 using the face images of the target speaker and using N number of acoustic signals input from the microphone array 10.

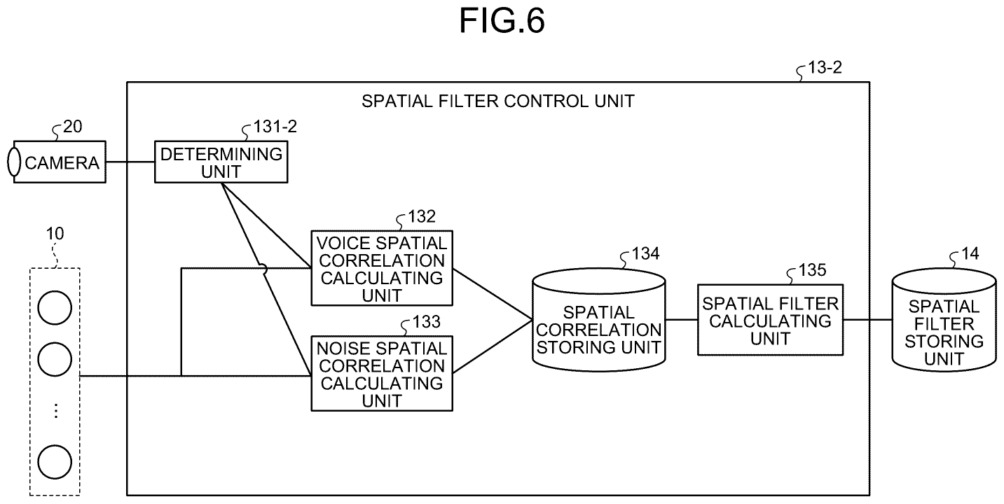

Explained below with reference to FIG. 6 are the functions of the spatial filter control unit 13-2 representing the characteristic part according to the second embodiment.

### Exemplary Functional Configuration of Spatial Filter Control Unit

FIG. 6 is a diagram illustrating an exemplary functional configuration of the spatial filter control unit 13-2 according to the second embodiment. The spatial filter control unit 13-2 according to the second embodiment is connected to the microphone array 10, the camera 20, and the spatial filter storing unit 14. The spatial filter control unit 13-2 includes a determining unit 131-2, the voice spatial correlation calculating unit 132, the noise spatial correlation calculating unit 133, the spatial correlation storing unit 134, and the spatial filter calculating unit 135.

The determining unit 131-2 determines, regarding the face images of the target speaker that are present in each frame input from the camera 20, whether or not the target speaker is making an utterance. For example, the determining unit 131-2 extracts the image of the lip region from the face images present in each frame and, if it is determined that the lip region is moving, determines that the target speaker is making an utterance. On the other hand, if it is determined that the lip region is not moving, the determining unit 131-2 determines that the target speaker is not making an utterance. In an identical manner to the first embodiment, the determining unit 131-2 outputs the determination result as a binary value of “0” or “1” or as a continuous value in the range from “0” to “1”. Then, the voice spatial correlation calculating unit 132 updates the spatial correlation storing unit 134 according to Equation (1), or Equation (2), or Equation (3) given earlier; and the noise spatial correlation calculating unit 133 updates the spatial correlation storing unit 134 according to Equation (4), or Equation (5), or Equation (6) given earlier. Meanwhile, the frame interval used in the acoustic signal processing by the spatial filter control unit 13 can be different than the frame interval used in video processing. For example, the spatial filter control unit 13 can further include a determination result storing unit for storing the determination result obtained by the determining unit 131-2. Then, using the determination result stored in the determination result storing unit, the spatial filter control unit 13 updates the spatial correlation storing unit 134.

As a method for extracting the lip region and detecting its movement, the Viola-Jones method (P. Viola and M. Jones 2001) is widely known. In order to prevent erroneous detection of the target utterance, only when the acoustic signals are determined to represent the target voice according to the method implemented in the acoustic signal processing device 1 according to the first embodiment, it can be determined that the target speaker is making an utterance. That is, the determining unit 131-2 can extract the images of the lip region from the face images and, when the lip region is determined to be moving and when the acoustic signals are determined to represent the acoustic signals, can determine that the target speaker is making an utterance.

Meanwhile, the parameters and the threshold value to be used in detecting the movement of the lip region can be set as constant numbers. Alternatively, an interface for externally setting the values can be provided.

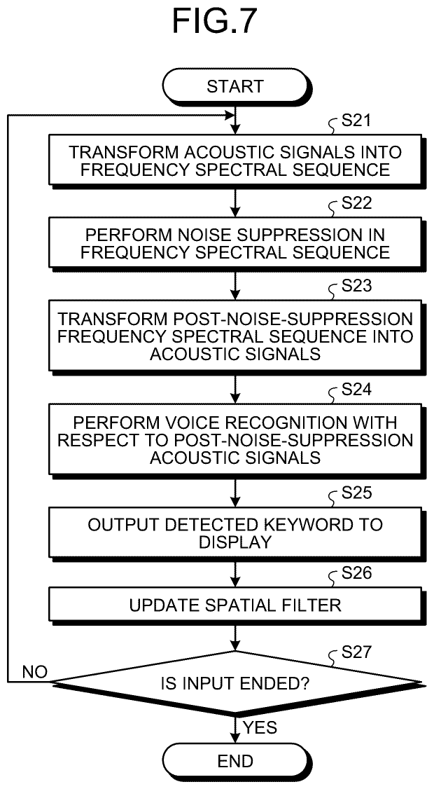

Example of acoustic signal processing method FIG. 7 is a flowchart for explaining an exemplary acoustic signal processing method according to the second embodiment. Herein, the operations from Step S21 to Step S25 are identical to the operations from Step S1 to Step S5 (see FIG. 3) according to the first embodiment. Hence, that explanation is not repeated.

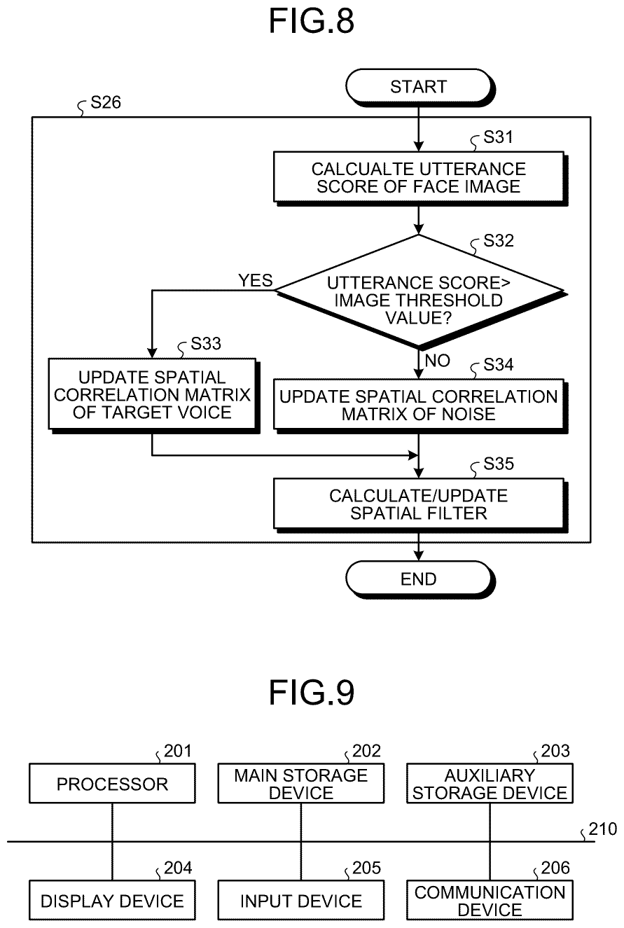

Subsequently, the spatial filter control unit 13-2 updates the value of the spatial filter in the spatial filter storing unit 14 using the acoustic signals input from the microphone array 10 and using the face images of the target speaker input from the camera 20 (Step S26). Regarding the operation performed at Step S26 (i.e., regarding an updating method for updating the spatial filter), the detailed explanation is given later with reference to FIG. 8.

The operation at Step S27 is identical to the operation at Step S7 according to the first embodiment. Hence, that explanation is not repeated.

### Exemplary Updating Method for Updating Spatial Filter

FIG. 8 is a flowchart for explaining an exemplary updating method for updating the spatial filter according to the second embodiment. Firstly, regarding a face image of the target speaker as input from the camera 20, the determining unit 131-2 calculates an utterance score indicating that the target speaker is making an utterance or not making an utterance (Step S31). Then, the determining unit 131-2 compares the utterance score with a predetermined image threshold value (or an externally-set image threshold value (Step S32).

If the utterance score is greater than the image threshold value (Yes at Step S32), then the voice spatial correlation calculating unit 132 updates the spatial correlation matrix of the target voice using the acoustic signals input from the microphone array 10 (Step S33).

If the utterance score is equal to or smaller than the image threshold value (No at Step S32), then the noise spatial correlation calculating unit 133 updates the spatial correlation matrix of the noise using the acoustic signals input from the microphone array 10 (Step S34).

Subsequently, the spatial filter calculating unit 135 calculates the value of the spatial filter using the spatial correlation matrix of the target voice and the spatial correlation matrix of the noise, and updates the value in the spatial filter storing unit 14 (Step S35).

In the conventional technology, it is difficult to achieve improvement in the recognition rate even in a noise environment without relying on the voice recognition result.

As explained above, in the acoustic signal processing device 1-2 according to the second embodiment, the determining unit 131-2 calculates the voice score using the face images of the target speaker. Thus, by using the microphone array 10 and the camera 20 as the input devices, not only the background noise can be suppressed but the utterances made by the speakers other than the target speaker can also be treated as noise and be suppressed. More particularly, using the image features such as the movement of the lip region of the target speaker as input from the camera 20, the target voice or the noise is determined. Whereby, when speakers other than the target speakers are present, the voices of those speakers can be suppressed.

Lastly, the explanation is given about an exemplary hardware configuration of the voice recognition device 100 (100-2) according to the first embodiment (the second embodiment). For example, the voice recognition device 100 (100-2) according to the first embodiment (the second embodiment) can be implemented using an arbitrary computer device as the basic hardware.

### Exemplary Hardware Configuration

FIG. 9 is a diagram illustrating an exemplary hardware configuration of the voice recognition device 100 (100-2) according to the first embodiment (the second embodiment). The voice recognition device 100 (100-2) according to the first embodiment (the second embodiment) includes a processor 201, a main storage device 202, an auxiliary storage device 203, a display device 204, an input device 205, and a communication device 206. The processor 201, the main storage device 202, the auxiliary storage device 203, the display device 204, the input device 205, and the communication device 206 are connected to each other via a bus 210.

Meanwhile, the voice recognition device 100 (100-2) need not include some part of the abovementioned configuration. For example, when it is possible to utilize the input function and the display function of an external device, the voice recognition device 100 (100-2) need not include the display device 204 and the input device 205.

The processor 201 executes a computer program that is read from the auxiliary storage device 203 into the main storage device 202. The main storage device 202 represents a memory such as a read only memory (ROM) or a random access memory (RAN). The auxiliary storage device 203 represents a hard disk drive (HDD) or a memory card.

The display device 204 is, for example, a liquid crystal display. The input device 205 represents an interface for operating the voice recognition device 100 (100-2). Meanwhile, the display device 204 and the input device 205 can alternatively be implemented using a touch-sensitive panel equipped with the display function and the input function. The communication device 206 represents an interface for communicating with other devices.

For example, the computer program executed in the voice recognition device 100 (100-2) is recorded as an installable file or an executable file in a computer-readable memory medium such as a memory card, a hard disk, a CD-RW, a CD-ROM, a CD-R, a DVD-RAM, or a DVD-R; and is provided as a computer program product.

Alternatively, for example, the computer program executed in the voice recognition device 100 (100-2) can be stored in a downloadable manner in a computer connected to a network such as the Internet.

Still alternatively, the computer program executed in the voice recognition device 100 (100-2) can be distributed via a network such as the Internet without involving the downloading task. More particularly, the configuration can be such that the voice recognition operation is performed according to, what is called, an application service provider (ASP) service in which, without transferring the computer program from a server computer, the processing functions are implemented only according to the execution instruction and the result acquisition.

Still alternatively, the computer program executed in the voice recognition device 100 (100-2) can be stored in advance in a ROM.

The computer program executed in the voice recognition device 100 (100-2) has a modular configuration that, from among the functional configuration explained earlier, includes functions implementable also by a computer program. As the actual hardware, the processor 201 reads the computer program from a memory medium and executes it, so that each such function gets loaded in the main storage device 202. That is, each functional block gets generated in the main storage device 202.

Meanwhile, some or all of the abovementioned functions can be implemented not by using software but by using hardware such as an integrated circuit (IC).

Moreover, the functions can be implemented using a plurality of processors 201. In that case, each processor 201 either can implement one of the functions, or can implement two or more functions.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An acoustic signal processing device comprising:
one or more hardware processors configured to function as:
a spatial filter control unit that outputs a spatial filter used for emphasizing a target voice component and for suppressing a noise component with respect to N number of temporally-synchronized acoustic signals recorded at different positions, N being an integer equal to or greater than 2;
a spatial filter storing unit that stores therein the spatial filter; and
an acoustic processing unit that, using the spatial filter read from the spatial filter storing unit,
emphasizes a target voice component in an acoustic signal, and
suppresses a noise component in the acoustic signal, wherein
the spatial filter control unit includes:
a determining unit that determines whether the acoustic signal represents a target voice or a noise,
a voice spatial correlation calculating unit that calculates a voice spatial correlation matrix using a voice section which, among the acoustic signals, is determined to represent the target voice,
a noise spatial correlation calculating unit that calculates a noise spatial correlation matrix using a noise section which, among the acoustic signals, is determined to represent the noise,
a spatial correlation storing unit that stores therein the voice spatial correlation matrix and the noise spatial correlation matrix, and
a spatial filter calculating unit that, from the voice spatial correlation matrix and the noise spatial correlation matrix read from the spatial correlation storing unit, calculates the spatial filter used for emphasizing the target voice component and for suppressing the noise component.

2. The acoustic signal processing device according to claim 1, wherein
at least
the voice spatial correlation calculating unit, when the determining unit determines that the acoustic signal represents the target voice, performs a voice spatial correlation matrix updating operation of reading the voice spatial correlation matrix from the spatial correlation storing unit, updating the voice spatial correlation matrix, and writing the updated voice spatial correlation matrix in the spatial correlation storing unit; or
the noise spatial correlation calculating unit, when the determining unit determines that the acoustic signal represents the noise, performs a noise spatial correlation matrix updating operation of reading the noise spatial correlation matrix from the spatial correlation storing unit, updating the noise spatial correlation matrix, and writing the updated noise spatial correlation matrix in the spatial correlation storing unit.

3. The acoustic signal processing device according to claim 1, wherein
the determining unit includes an acoustic signal storing unit that stores therein acoustic signals included before a predetermined period of time from a current timing,
the determining unit determines whether or not an acoustic signal included before the predetermined period of time from the current timing represents the target voice, and
using acoustic signals included before the predetermined period of time from the current timing, the voice spatial correlation calculating unit and the noise spatial correlation calculating unit
update the voice spatial correlation matrix and the noise spatial correlation matrix, respectively, and
store the updated voice spatial correlation matrix and the updated noise spatial correlation matrix, respectively, in the spatial correlation storing unit.

4. The acoustic signal processing device according to claim 1, wherein
the determining unit includes an acoustic signal storing unit that retains acoustic signals included before a predetermined period of time from current timing,
the determining unit determines whether or not an acoustic signal before the predetermined period of time represents the noise, and
the voice spatial correlation calculating unit updates the voice spatial correlation matrix using acoustic signals at the current timing and stores the updated voice spatial correlation matrix in the spatial correlation storing unit, and
when the acoustic signal before the predetermined period of time is determined to represent the noise, the noise spatial correlation calculating unit updates the noise spatial correlation matrix using acoustic signals before the predetermined period of time and stores the updated noise spatial correlation matrix in the spatial correlation storing unit.

5. The acoustic signal processing device according to claim 1, wherein the determining unit
calculates a value of a voice score indicating voice-likeness of the acoustic signals,
when the voice score is greater than a voice threshold value, determines that the acoustic signal represents the target voice, and
when the voice score is equal to or smaller than the voice threshold value, determines that the acoustic signal represents the noise.

6. The acoustic signal processing device according to claim 1, wherein the determining unit
calculates, with respect to the acoustic signals, a voice score indicating voice-likeness and a noise score indicating noise-likeness,
when the voice score is greater than a voice threshold value, determines that the acoustic signal represents the target voice, and
when the noise score is greater than a noise threshold value, determines that the acoustic signal represents the noise.

7. The acoustic signal processing device according to claim 5, wherein
the determining unit includes a sound source count estimator that estimates a number of sound sources involved with the acoustic signals, and
the voice score is expressed by a function of the number of sound sources.

8. The acoustic signal processing device according to claim 5, wherein the voice score is expressed by a function of statistic based on power of the acoustic signals.

9. The acoustic signal processing device according to claim 1, wherein the determining unit
uses a face image of a target speaker and calculates an utterance score indicating that the target speaker is making an utterance or not making an utterance,
when the utterance score is greater than an image threshold value, determines that the acoustic signal represents the target voice, and
when the utterance score is equal to or smaller than the image threshold value, determines that the acoustic signal represents the noise.

10. The acoustic signal processing device according to claim 1, wherein
the spatial filter control unit includes
a speaker direction setting unit that holds a relative direction of a target speaker when viewed from a microphone, and
a sound source localizing unit that performs sound source localization with respect to the acoustic signals and outputs a detected sound source direction,
for at least one of sound source directions,
when an angular difference from the relative direction set by the speaker direction setting unit is equal to or smaller than an angle threshold value, the determining unit determines as the target voice, and
when the angular difference is greater than the angle threshold value, the determining unit determines as the noise.

11. The acoustic signal processing device according to claim 1, wherein
the spatial filter control unit includes a sound source separating unit that performs sound source separation with respect to the acoustic signals that are input, and outputs separation acoustic signals that are separated into the target voice component and the noise component, and
the separation acoustic signals are input to at least one of the determining unit, the voice spatial correlation calculating unit, the noise spatial correlation calculating unit, and the acoustic processing unit.

12. The acoustic signal processing device according to claim 1, wherein acoustic signals output from the acoustic processing unit are input to at least one of the determining unit, the voice spatial correlation calculating unit, and the noise spatial correlation calculating unit.

13. The acoustic signal processing device according to claim 1, wherein
the determining unit outputs a continuous value indicating a degree of the acoustic signal representing the target voice,
the voice spatial correlation calculating unit calculates the voice spatial correlation matrix such that, as the continuous value is increased, weighting of a proportion of updating values of the voice spatial correlation matrix is made to be increased, and
the noise spatial correlation calculating unit calculates the noise spatial correlation matrix such that, as the continuous value is decreased, weighting of a proportion of updating values of the noise spatial correlation matrix is made to be increased.

14. The acoustic signal processing device according to claim 1, wherein the determining unit
calculates, for the acoustic signals, a target-voice score indicating target-voice-likeness and a noise score indicating noise-likeness,
when the target-voice score is greater than a voice threshold value, determines that the acoustic signal represents the target voice, and
when the noise score is greater than a noise threshold value, determines that the acoustic signal represents the noise.

15. An acoustic signal processing method implemented by a computer of the acoustic signal processing device, the method comprising:
outputting a spatial filter used for emphasizing a target voice component and for suppressing a noise component with respect to N number of temporally-synchronized acoustic signals recorded at different positions, N being an integer equal to or greater than 2;
storing the spatial filter in a spatial filter storing unit; and
acoustic-processing that includes
using the spatial filter read from the spatial filter storing unit,
emphasizing a target voice component in an acoustic signal, and
suppressing a noise component in the acoustic signal, wherein
the outputting of the spatial filter includes
determining whether the acoustic signal represents a target voice or a noise,
calculating a voice spatial correlation matrix using a voice section which, among the acoustic signals, is determined to represent the target voice,
calculating a noise spatial correlation matrix using a noise section which, among the acoustic signals, is determined to represent the noise,
storing the voice spatial correlation matrix and the noise spatial correlation matrix in a spatial correlation storing unit, and
calculating, from the voice spatial correlation matrix and the noise spatial correlation matrix read from the spatial correlation storing unit, the spatial filter used for emphasizing the target voice component and for suppressing the noise component.

16. A computer program product having a non-transitory computer readable medium including programmed instruction stored therein, wherein the instructions, when executed by a computer, cause the computer to function as:
a spatial filter control unit that outputs a spatial filter used for emphasizing a target voice component and for suppressing a noise component with respect to N number of temporally-synchronized acoustic signals recorded at different positions, N being an integer equal to or greater than 2;
a spatial filter storing unit that stores therein the spatial filter; and
an acoustic processing unit that, using the spatial filter read from the spatial filter storing unit,
emphasizes a target voice component in an acoustic signal, and
suppresses a noise component in the acoustic signals, wherein
the spatial filter control unit includes
a determining unit that determines whether the acoustic signal represents a target voice or a noise,
a voice spatial correlation calculating unit that calculates a voice spatial correlation matrix using a voice section which, among the acoustic signals, is determined to represent the target voice,
a noise spatial correlation calculating unit that calculates a noise spatial correlation matrix using a noise section which, among the acoustic signals, is determined to represent the noise,
a spatial correlation storing unit that stores therein the voice spatial correlation matrix and the noise spatial correlation matrix, and
a spatial filter calculating unit that, from the voice spatial correlation matrix and the noise spatial correlation matrix read from the spatial correlation storing unit, calculates the spatial filter used for emphasizing the target voice component and for suppressing the noise component.
